(19) United States
(12) Patent Application Publication
(10) Pub. No.: US 2015/0192105 A1
(43) Pub. Date: Jul. 9, 2015

(54) ROTORS FOR EXTRACTING ENERGY FROM WIND AND HYDROKINETIC SOURCES

(71) Applicant: Hing Kwok Dennis Chu, Monterey Park, CA (US)

(72) Inventor: Hing Kwok Dennis Chu, Monterey Park, CA (US)

(21) Appl. No.: 14/151,060

(22) Filed: Jan. 9, 2014

(51) Int. Cl. F03D 1/06

(52) U.S. Cl. CPC F03D 1/06

(57) ABSTRACT

Rotors for devices such as wind turbines have one or more blades that each include a first airfoil, and a second airfoil positioned proximate the first airfoil so that the first and second airfoils interact aerodynamically during rotation of the rotor. The first airfoil can be configured to pivot so that its angle of attack remains approximately zero.

### BACKGROUND

1. Statement of the Technical Field

The concepts disclosed herein relate to devices having a rotor configured to extract energy from wind and hydrokinetic sources. The concepts are applicable to horizontal and vertical-axis wind turbines, and can also be applied to aircraft, hydrofoils, and other devices.

2. Description of Related Art

Wind turbines are widely used to generate electricity. A wind turbine typically includes a rotor, a generator, and a gearbox that couples the rotor to the generator. The rotor extracts energy from wind passing over it. The rotor is equipped with one or more blades or airfoils that interact aerodynamically with the wind so that the wind imparts rotation to the rotor. The resulting torque generated by the rotor is transmitted to the generator via the gearbox. The gearbox typically increases the angular velocity of the rotational output of the rotor to a value suitable for operating the generator. The generator has a rotor that rotates within a magnetic field in response to the rotational input from the gearbox, resulting in the generation of electricity in the winding of the generator.

Rotors can be equipped with airfoils that are attached at one end to a central hub, and extend radially outward from the hub so that the blades rotate in a vertically-oriented plane. This configuration is commonly referred to as a “horizontal axis wind turbine,” or HAWT, because the axis of rotation of the rotor is oriented horizontally, or parallel to the ground. HAWTs are currently used more often than vertical axis wind turbines, or VAWTs, especially in large commercial wind farms. The rotor of a HAWT typically is more efficient at converting wind energy into a rotational power output in comparison to a VAWT of comparable size. HAWTs, however, are generally heavier than VAWTs, and do not operate as well as VAWTs under turbulent wind conditions. Also, HAWTs are affected by the direction of the relative wind incident thereon, and the cost of a HAWT is usually higher than that of a comparable VAWT.

The rotor of a VAWT is equipped with airfoils that extend generally in a vertical direction, so that the rotor rotates about an axis that extends perpendicular to the ground. VAWTs are generally insensitive to wind direction, and thus operate well in turbulent and unsteady wind conditions. Accordingly, VAWTs are often used in smaller-size applications where zoning ordinances or other factors prevent the rotor from being mounted at a height sufficient to subject the rotor to steady wind conditions.

The rotor of a VAWT can be configured, for example, as a cyclogyro. In a cyclogro-type rotor, a plurality of airfoils are mounted on a rigid frame so that the axis of each airfoil extends vertically. The airfoils are spaced apart from the vertical axis of the frame by the same distance, so that the airfoils rotate about the central axis of the frame along a common angular path, or circle. This particular type of VAWT can have a higher theoretical energy conversion efficiency than a comparable HAWT. Most cyclogyro rotors operate at a tip speed ratio between three and seven; optimal efficiency, however, can only be achieved within a narrow band within this operating range. Moreover, the rotors of most VAWTs, including cyclogyros, will experience a deep dynamic stall when operating at a tip speed ratio of two or less. A deep dynamic stall can substantially increase the vibration level and substantially decrease the energy output of rotor.

### SUMMARY

Rotors for extracting energy from a moving fluid include a frame, and a first airfoil mounted on the frame and configured to pivot in relation to the frame. The rotors also have a second airfoil fixed to the frame proximate the first airfoil so that the second airfoil interacts aerodynamically with the first airfoil in response to the moving fluid.

Rotors for extracting energy from a fluid include a frame, and a first airfoil coupled to the frame. The first airfoil is operative to generate a downwash in response to relative movement between the first blade and the fluid. The rotors also include a second airfoil fixed to the frame proximate the first airfoil so that at least a portion of an upper surface of the second airfoil is positioned within the downwash of the first airfoil.

Devices for producing electricity include a generator, and a rotor configured to extract energy from a moving fluid. The rotor has a frame coupled to the generator and configured to impart torque to the generator. The generator generates electricity in response to the torque. The rotor also has a first airfoil that is mounted on the frame and is configured to pivot in relation to the frame. The rotor further includes a second airfoil fixed to the frame proximate the first airfoil so that the second airfoil interacts aerodynamically with the first airfoil in response to the moving fluid.

### BRIEF DESCRIPTION OF THE DRAWINGS

Embodiments will be described with reference to the following drawing figures, in which like numerals represent like items throughout the figures and in which:

FIG. 1 is a perspective view of a vertical-axis wind turbine;

FIG. 2 is a top view of a rotor of the vertical-axis wind turbine shown in FIG. 1;

FIG. 3 is a top or end view of a front airfoil and a main airfoil of the rotor shown in FIGS. 1 and 2;

FIG. 4 is a perspective, partial cut-out view of the front blade shown in FIGS. 1-3;

FIG. 5 is a top or end view of the front and main blades shown in FIGS. 1-4, at various clock positions during operation thereof;

FIG. 6 is a top or end view of the front airfoil shown in FIGS. 1-5, depicting various forces acting on the front airfoil during operation thereof;

FIG. 7 is a table listing various design and operating characteristics of the front and main airfoils shown in FIGS. 1-6;

FIG. 8 is a table listing various operating parameters for the rotor shown in FIGS. 1 and 2;

FIG. 9 depicts a predicted flow field associated with a conventionally-configured airfoil;

FIG. 10 is a schematic illustration depicting the flow circulation around the conventionally-configured airfoil shown in FIG. 9;

FIG. 11 is a schematic illustration depicting the flow circulation around the front and main airfoils shown in FIGS. 1-6;

FIG. 12 further depicts the predicted flow field associated with the conventionally-configured airfoil shown in FIGS. 9 and 10;

FIG. 13 depicts a predicted flow field associated with the front and main airfoils shown in FIGS. 1-6 and 11;

FIG. 14 is a front view of a horizontal-axis wind turbine;

FIG. 15 depicts a predicted flow field associated with a front airfoil and a main airfoil of the wind turbine shown in FIG. 14;

FIG. 16 is a table listing various design and operating characteristics of the front and main airfoils shown in FIGS. 14 and 15; and

FIG. 17 is a top view of a rotor of an alternative embodiment of the vertical-axis wind turbine shown in FIGS. 1-6.

### DETAILED DESCRIPTION

The inventive concepts are described with reference to the attached figures. The figures are not drawn to scale and they are provided merely to illustrate the instant inventive concepts. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts. The inventive concepts is not limited by the illustrated ordering of acts or events, as some acts may occur in different orders and/or concurrently with other acts or events. Furthermore, not all illustrated acts or events are required to implement a methodology in accordance with the inventive concepts.

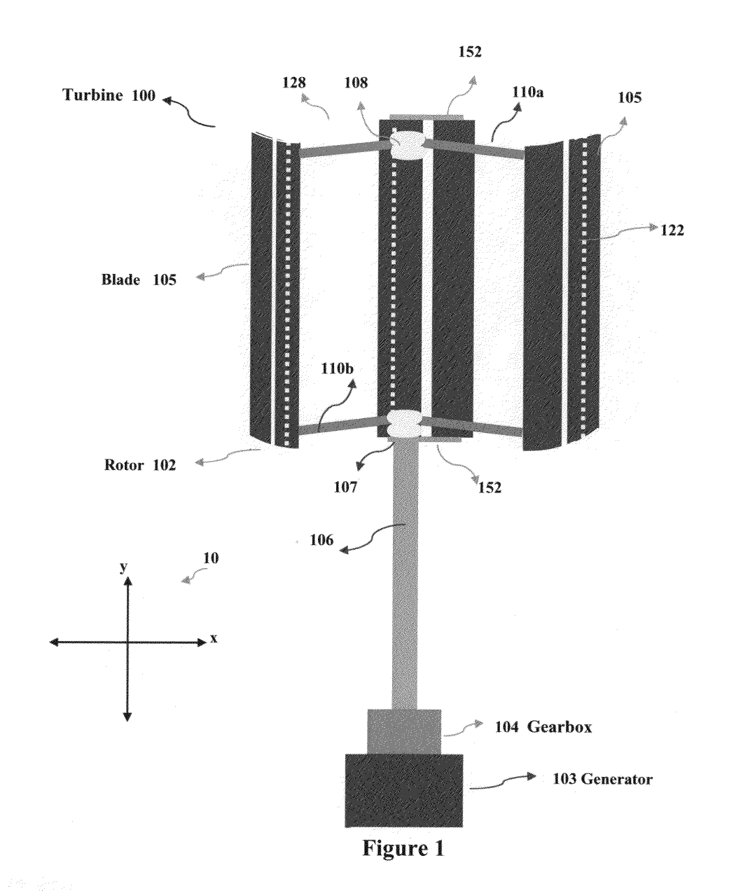

FIG. 1 depicts a wind turbine 100. The wind turbine 100 comprises a vertical-axis rotor 102. The wind turbine 100 also includes a generator 103, and a gearbox 104. The gearbox 104 is coupled to the rotor 102 and the generator 103, and transmits torque generated by the rotor 102 to the generator 103. The gearbox 104 receives the rotational output of the rotor 102, and increases the rotational velocity thereof so that the generator 103 receives a rotational input having a higher rotational velocity than the rotor 102. The generator 103 generates electricity in response to the rotational input thereto. The term “generator,” as used herein, is intended to encompass devices that generate an electrical output in the form of either direct current or alternating current.

The rotor 102 is a constant-speed rotor, and comprises three airfoil sets, or dual-airfoil blades 105. The inventive concepts are described herein in connection with a constant-speed rotor for exemplary purposes only; the inventive concepts can also be applied to variable-speed rotors.

The lengthwise direction of each blade 105 is oriented substantially in the vertical (“y”) direction. The “x,” “y,” and “z” directions are denoted by the key 10 included in select figures. Directional terms such as “vertical” and “horizontal” are used with reference to the component orientations shown in FIG. 1; these terms are used for exemplary purposes only, and are not intended to limit the scope of the appended claims.

The rotor 102 further includes a vertically-oriented main shaft 106, a lower hub 107, and an upper hub 108. The lower hub 107 is fixed to the main shaft 106 by a suitable means such as pins, fasteners, threads, interference fit, etc. The lower hub 107 and the main shaft 106 can be integrally formed in alternative embodiments.

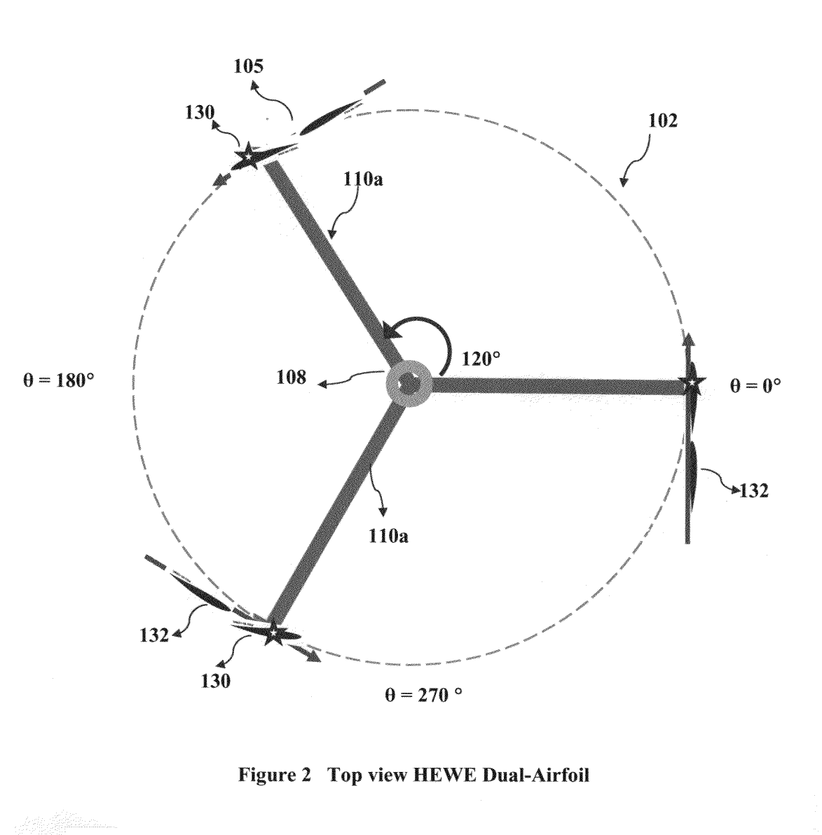

The rotor 102 further includes three upper arms or struts 110a, and three lower arms or struts 110b, as shown in FIGS. 1 and 2. A first, or inner end of each lower strut 110b is fixed to the lower hub 107 by fasteners or other suitable means. The lower hub 107 and the lower struts 110b can be integrally formed in the alternative. The lower struts 110b extend radially outward from the lower hub 107, as shown in FIG. 1. The lower struts 110b are equally spaced, so that the angular spacing between adjacent lower struts 110b is approximately 120°.

A first, or inner end of each upper strut 110a is fixed to the upper hub 108 by fasteners or other suitable means. The upper hub 108 and the upper struts 110a can be integrally formed in the alternative. The upper struts 110a extend radially outward from the upper hub 108, as shown in FIGS. 1 and 2. Each upper strut 110a is vertically aligned with, i.e., is positioned directly above, an associated lower strut 110b. The upper struts 110a are equally spaced, so that the angular spacing between adjacent upper struts 110a is approximately 120°. The blades 105, as discussed below, are mounted on the upper and lower struts 110a, 110b. The blades 105, therefore, are equally spaced in the angular direction, so that corresponding points on adjacent blades 105 are separated by an angular distance of approximately 120°.

The rotor 102 further includes three support shafts 122. Each shaft 122 extends substantially in the vertical direction, between an associated lower strut 110b and upper strut 110a as depicted in FIG. 1. A first, or lower end of each shaft 122 is fixed to a second, or outer end of its associated lower strut 110b by fasteners or other suitable means. A second, or upper end of each shaft 122 is fixed to a second, or outer end of its associated upper strut 110a by fasteners or other suitable means. The upper hub 108, lower hub 107, upper struts 110a, lower struts 110b, and support shafts 122 form a rigid, “bird-cage-type” frame 128 that supports the blades 105 and transfers torque between the blades 105 and the generator 103.

Each blade 105 includes a first, or front airfoil 130, and a second, or main airfoil 132 located proximate front airfoil 130. Each main airfoil 132 is positioned proximate an associated front airfoil 130, as shown in FIGS. 1-3, 5, 11, and 13. The front and main airfoils 130, 132 of each blade 105 are positioned so that the circulation flow that develops around the front airfoil 130 during rotation of the rotor 102 interacts with the circulation flow that develops around the associated main airfoil 132. As discussed below, the interaction of the circulation flows increases the imbalance between the pressure distributions across the top and bottom surfaces of front airfoil 130. The interaction of the circulation flows likewise increases the imbalance between the pressure distributions across the top and bottom surfaces of rear airfoil 132. This effect increases the lift generated by the front and main airfoils 130, 132, resulting in an increase in the torque produced by the rotor 102.

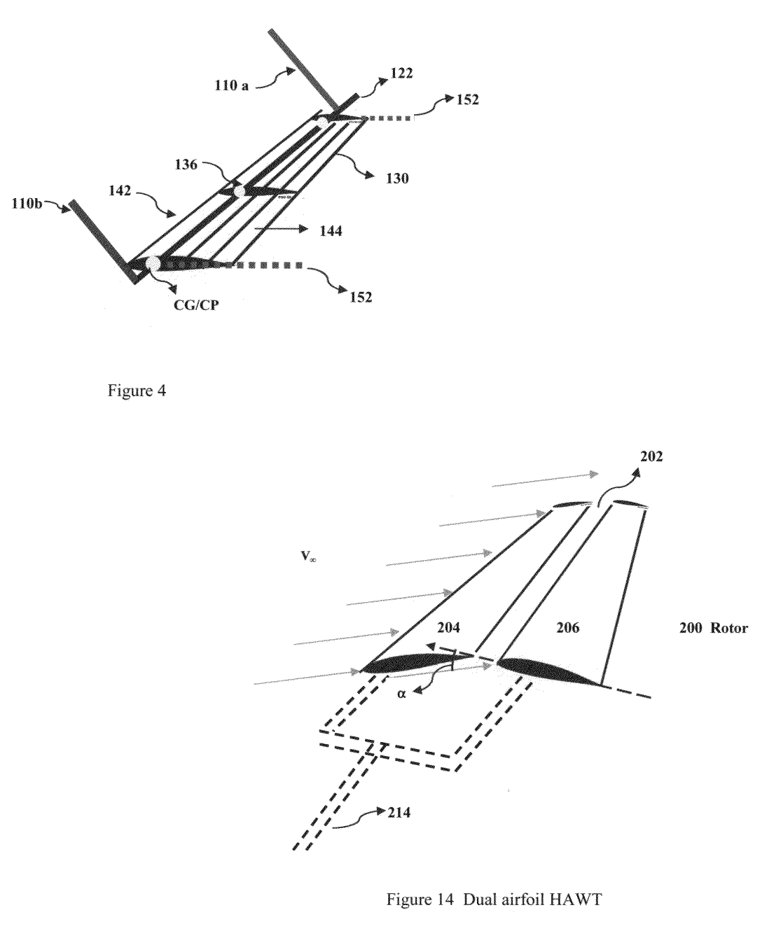

The front airfoils 130 of the three blades 105 are substantially identical, and unless otherwise stated, the following description applies equally to all three front airfoils 130. The front airfoil 130 comprises a rigid frame 142, and a skin 144 that covers the frame 142, as shown in FIG. 4. The skin 144 can be formed from aluminum, epoxy resin, or other suitable materials.

The front airfoil 130 is coupled to an associated support shaft 122, so that the front airfoil 130 extends substantially in the vertical (y) direction as depicted in FIG. 1. The shaft 122 is disposed in a cavity formed in the front airfoil 130. The support shaft 122 extends through the front airfoil 130 over the length of the front airfoil 130 as illustrated in FIG. 4. The longitudinal axis of the support shaft 122 is substantially coincident with the center of gravity of the front airfoil 130. The center of gravity of the front airfoil 130 is denoted in the figures by the reference character “CG.”

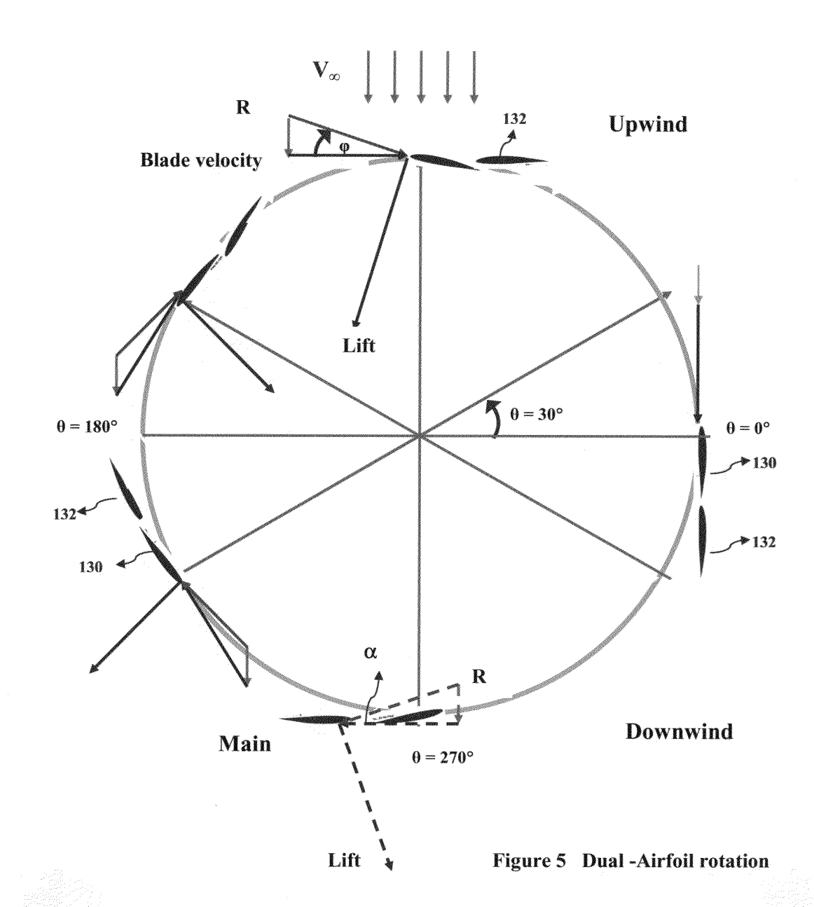

The front airfoil 130 is coupled to its associated support shaft 122 by bearings 136 or other suitable means that permit the front airfoil 130 to rotate or pivot freely in relation to the support shaft 122. The bearings 136 are depicted in FIG. 4. The pivot axis of the front airfoil 130 extends substantially in the vertical direction, and is substantially coincident with the center of gravity of the front airfoil 130. The front airfoil 130 includes stops (not shown) that limit the range of pivotal movement of the front airfoil 130 from approximately +15° to approximately −5° (from the perspective of FIG. 5). As discussed below, this feature can help to optimize the aerodynamic performance of the blades 105.

Each of the main airfoils 132 comprises a rigid frame (not shown), and a skin that covers the frame. The skin can be formed from aluminum, epoxy resin, or other suitable materials. The shafts 152 associated with the main airfoil 132 are fixed to the frame thereof

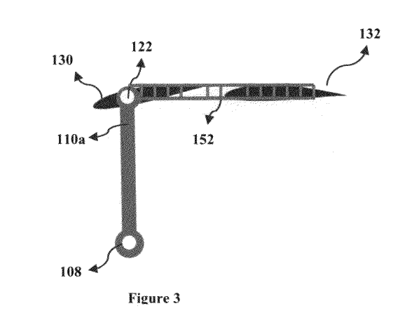

The main airfoils 132 are each mounted on two associated shafts 152, as shown in FIGS. 1 and 3. A first end of each shaft 152 is fixed to the associated main airfoil 132 using fasteners or other suitable means, so that the longitudinal axis of the main airfoil 132 is substantially perpendicular to the shafts 152. A second end of each shaft 152 is fixed to the associated support shaft 122 as depicted in FIG. 3. Each shaft 152 extends substantially in the horizontal direction. This arrangement causes the longitudinal axis of the main airfoil 132 to extend substantially in the vertical direction. Other mounting arrangements for the main airfoil 132 can be used in the alternative.

The main airfoil 132 has a chord “cₘ.” The angle between the chord cₘ, and a line tangent to the direction of rotation of the main airfoil 132 is referred to herein as the “pitch angle” of the main airfoil 132, and is denoted by the reference character “Φₘ.” The angle between the chord cₘ of the main airfoil 132 and the relative wind (“R”), i.e., the direction of the airflow incident upon the main airfoil 132, represents the angle of attack “αₘ” of the main airfoil 132. The angular position of the main airfoil 132 is fixed in relation to its associated upper strut 110a and lower strut 110b, i.e., the main airfoil 132 is not configured to pivot in relation to the upper strut 110a and lower strut 110b. Accordingly, the pitch angle Φₘ of the main airfoils 132 is fixed at approximately zero as shown in FIG. 5, which depicts the main airfoil 132 and the front airfoil 130 of one blade 105 as the blade 105 moves along its path of travel. Moreover, the angle of attack αₘ of the main airfoils 132 varies between approximately zero and approximately 15° when the rotor 102 is operating at a tip speed ratio (“λ”) of approximately four.

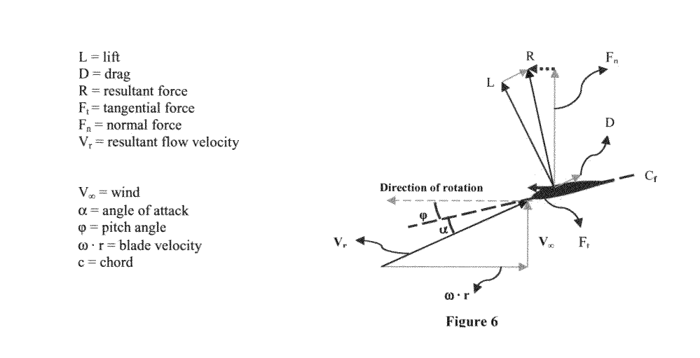

The front airfoil 130 has a chord “c^{f}”, as illustrated in FIG. 6. The angle between the chord c_{f} and a line tangent to the direction of rotation of the front airfoil 130 is referred to herein as the “pitch angle” of the font airfoil 130, and is denoted by the reference character “Φ_{f}.” As noted above, the front airfoil 130 is configured to freely pivot so that its pitch angle changes as the front airfoil 130 moves along its path of travel. When the rotor 102 is operating at a tip speed ratio λ of approximately four, the pitch angle Φ_{f} varies between approximately zero and approximately 15°.

The angle between the chord c_{f} of the front airfoil 130 and the relative wind R incident upon the front airfoil 130 represents the angle of attack “α_{f}” of the front airfoil 130. As discussed below, the angle of attack of the front airfoil 130 remains approximately zero during operation of the rotor 102 as a result of the ability of the front airfoil 130 to pivot.

The front airfoil 130 is symmetric, i.e., the front airfoil 130 is disposed symmetrically about its chord c_{f}, as shown in FIG. 6. The aerodynamic forces acting on the front airfoil 130 during movement of the rotor 120 produce a center of pressure (“CP”) on the front airfoil 130. The center of pressure is located at about the one-third chord point, i.e., about one-third of the way from the leading edge along the chord c_{f}. Due to the symmetrical configuration of the front airfoil 130 and the circulation effect from the main airfoil, the location of the center of pressure CP remains at about the one-third chord point during operation of the wind turbine 100.

The centrifugal forces acting on the front airfoil 130 as a result of the rotation of the rotor 102 are substantially balanced about the center of gravity CG of the front airfoil 130. Thus, the net moment generated by the centrifugal forces is approximately zero at the center of gravity. The aerodynamic forces acting on the front airfoil 130 are balanced about the center of pressure CP. Accordingly, the net moment generated by the aerodynamic forces is approximately zero at the center of pressure. The front airfoil 130 is configured so that its center of gravity CG is substantially coincident with the center of pressure CP. Thus, during operation of the rotor 102, the centrifugal and aerodynamic forces acting on the front airfoil 130 are substantially balanced about the same axis, i.e., center of pressure and the co-located center of gravity, and the net moment on the front airfoil 130 is approximately zero.

The front airfoil 130 self-adjusts its position so as it follows the relative wind R during operation of the rotor 102, thereby causing the angle of attack α_{f} of the front airfoil 130 to remain substantially zero. This characteristic is a result of the ability of the front airfoil 130 to freely pivot about the co-located center of gravity and center of pressure, the absence of a net moment about the center of gravity and center of pressure, and the symmetrical configuration of the front airfoil 130.

FIG. 5 depicts one of the blades 105 of the rotor 102 at various clock positions. The reference frame included in FIG. 5 depicts an azimuth angle θ. The azimuth angle θ is defined as zero when the velocity of the blade 105 is parallel to the wind, or free stream airflow V_{∞}. The azimuth angle θ increases in the counterclockwise direction, reaching 90° and 270° when the velocity of the blade 105 is perpendicular to the free stream airflow V_{∞}. The azimuth angle is 180° when the velocity of the blade 105 is anti-parallel to the free stream airflow V_{∞}.

The relative wind Vᵣ incident on the airfoils 105 creates a pressure differential across the front airfoil 130 and main airfoil 132. The pressure differential imposes lift and drag forces on the front and main airfoils 130, 132. The lift and drag forces each can be resolved into a tangential force (Fₜ) and a normal force (Fₙ). The tangential force Fₜ produces torque that pulls the blade 105 forward, in the direction of rotation. The aggregate torque produced by the three blades 105 is transmitted to the generator 103 after being reduced in the gearbox 104, and results in the generation of electricity by the generator 103. The normal force Fₙ produces load and vibration on the rotor 102.

The velocity Vᵣ of each blade 105 changes constantly with the angular position of the blade 105. The Reynolds number associated with the flow over each blade 105 also changes with the angular position of the blade 105. As discussed above, because the front airfoils 130 freely pivot about their longitudinal axes so as to vary the pitch angle Φ_{f} thereof, the chord c_{f} of each front airfoil 105 constantly aligns itself with the relative wind Vᵣ during rotation of the rotor 102, and the angle of attack αf of the front airfoil 130 remains approximately zero during rotation of the rotor 102.

It is believed that the passive aerodynamic power control provided by the variable pitch of the front airfoils 130 can substantially increase the lift coefficient C₁ and aerodynamic efficiency of the blades 105 in relation to comparable fixed-pitch blades. Increases in aerodynamic efficiency can yield additional rotor torque, with relatively low power loss. This potential benefit is believed to be greatest when the front airfoils 130 are located at the front side and back side of the rotor, i.e., at azimuth angles θ of 35°-135° and 215°-315° as depicted in FIG. 5, where the lift vector L has larger tangential component.

It is also believed that the variable pitch of the front airfoils 130 can help eliminate flow separation, and the shedding of vortex-like disturbances over the upper surface of the front airfoils 130. Flow separation and vortex shedding can reduce lift, and can induce deep dynamic stall. Deep dynamic stall is highly undesirable due to its adverse effect on noise generation, vibration, and power output, which in turn can reduce the efficiency and life span of the rotor 102.

Without the self-adjusting pitch-angle control of the front airfoils 130, the air flow around a vertical-axis rotor can become complicated in the downwind sector, i.e., at azimuth angles θ from 180° to zero. As the blades of such a rotor complete a full rotation about their rotational axis, the velocity of the relative wind Vᵣ can be expected to vary by approximately 60 percent, while the relative angle of attack of the blades varies by approximately 42 percent. Due to these fluctuations, the tangential and radial forces on the blades will vary in time, resulting in a cyclic loading and unloading of the blades and other components of the wind turbine. As a further undesirable complication, the passage of the upstream blades through the air will result in a decrease of flow momentum on the downstream blades, and in the formation of shedding vortices that will impinge on downstream blades.

Further analysis has indicated that, without the self-adjusting pitch-angle control of the front airfoils 130, the fluctuation of aerodynamic parameters such as angle of attack α, the velocity of the relative wind Vᵣ, dynamic pressure, etc. occurs at a faster rate in the leeward region (90°-270°) than in the windward region (270°-90°). For a fixed blade operating between azimuth angles of 90° and 270°, the direction of the free stream air velocity V_{∞} is opposite the blade velocity, resulting in a canceling effect that lowers the relative velocity Vᵣ; whereas between azimuth angles 270°-90° V_{∞} and blade velocity are in the same direction, resulting in an additive effect that increases the relative velocity Vᵣ. Moreover, at low tip speed ratios (λ<4), the angle of attack of a fixed blade can exceed the static stall angle, which can result in dynamic stall.

It is believed that the above-noted changes between upwind and downwind operating conditions can be reduced through the variable-pitch feature of the front airfoils 130. In addition, for some larger turbines it is believed that these fluctuations can be further reduced by configuring the blades 105 to operate at a tip speed ratio λ of approximately 3.0. Operating the rotor 102 at this moderate velocity will prevent a downstream blade 105 from crossing its own wake, or the wakes of its upstream blades 105. Furthermore, the cage-like configuration of the rotor eliminates the need for a centrally-located vertical shaft. Accordingly, there are no wake losses that otherwise could occur due to the presence of such a shaft.

In a steady wind stream, the aerodynamic torque generated in the upwind sectors, i.e., at azimuth angles θ from zero to 180° as depicted in FIG. 5, is larger than that generated in the downwind sector. The ability of the front airfoils 130 to freely pivot about their respective longitudinal axes allows the front airfoils 105 to self-adjust to the relative wind Vᵣ so that the angle of attack α_{f} of each front airfoil 130 remains approximately zero. The ability of the front airfoils 130 to operate at an angle of attack of approximately zero throughout the upwind and downwind sectors, it is believed, helps to maximize the amount of energy extracted from the airflow passing over the front airfoils 105 during upwind and downwind travel thereof.

Because the pitch angle Φₘ of the main airfoils 132 is fixed at approximately zero, the main airfoils 132 remain tangentially aligned to the local radius of rotation, and the angle of attack αₘ of each main airfoil 132 fluctuates between approximately zero and approximately 15° as the main airfoil 132 traverses the upwind sectors. The above-noted interaction between the circulation fields of each front airfoil 130 and its corresponding main airfoil 132, which increases the imbalance between pressure distributions along the respective upper and lower surfaces of the front airfoils 130 and the main airfoils 132, is believed to substantially increase the lift generated by each front airfoil 130 and main airfoil 132 in the upwind sectors.

When the front airfoils 130 are operating in the downwind sectors, i.e., at azimuth angles θ from 180° to zero, an associated loss of flow momentum and a rise of unsteady flow phenomena will cause the pitch angle Φ_{f} of the front airfoils 130 to fluctuate between approximately zero and approximately 5°. This operating characteristic helps to minimize flow separation, and the generation and shedding of vortices from the front and main airfoils 130, 132.

The lift generated by the front airfoils 130 and the main airfoils 132 is approximately equal to zero as the blades 105 pass through azimuth angles θ of approximately zero and approximately 180°. Moreover, the lift force L generated by the front airfoils 130 and the main airfoils 132 changes direction from the perspective of FIG. 5, and the angle of attack αₘ of the main airfoils 132 changes from positive to negative and negative to positive, respectively, as the blades 105 pass through azimuth angles θ of approximately zero and approximately 180°.

As each blade 105 passes through an azimuth angle θ of 90°, the pitch angle Φ_{f} of the front airfoil 130 is approximately +15°, and the angle of attack αₘ of attack of the main airfoil 132 is approximately −15°. The velocity vector of the blade 105 and the direction of the relative wind Vᵣ are mutually perpendicular at these locations, and relatively large tangential forces pull the blade 105 forward. As each blade 105 passes through azimuth angles of zero and 180°, the pitch angle Φ_{f} of the front airfoil 130 is approximately zero, and the angle of attack αₘ of the main airfoil 132 is approximately zero. As each blade 105 passes through an azimuth angle of 270°, the pitch angle Φ_{f} of the front airfoil 130 is approximately −5°, and the angle of attack αₘ of the main airfoil 132 is approximately 5°. As discussed above, the pitch angle Φₘ of the main airfoils is fixed at zero, and the pivoting configuration of the front airfoils 130 causes the angle of attack α_{f} of the front airfoils 130 to remain approximately zero during operation of the rotor 102.

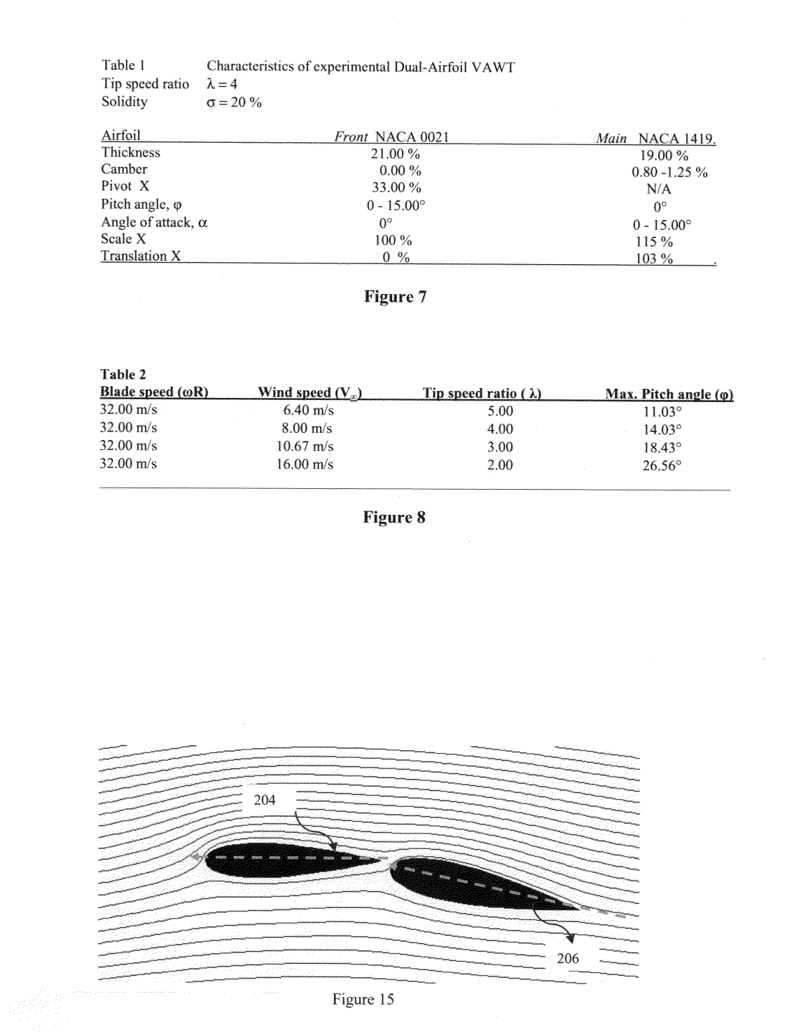

To help achieve optimal performance from a rotor such as the rotor 102, it is desirable that the front airfoils 130 and the main airfoils 132 each have a relatively high lift coefficient C₁, a relatively low drag coefficient C_{d}, and a relatively low sensitivity to standard roughness effect. In variable-speed-rotor applications, constant power output and favorable wake-loss control represent additional operating parameters that should be taken into consideration when optimizing the airfoil configuration. The inventor, through experimentation, testing, and analysis, has developed some potential configurations for the front airfoil 130 and the main airfoil 132. Details of one particular configuration, reflected in the rotor 102 described herein, are set forth in the table presented as FIG. 7. The inventor has found that the rotor 102, when configured in this manner, can operate within its designated range of operation at a high efficiency, with minimal drag, and with no stalling.

The particular configuration for the rotor 102 specified in FIG. 7 and otherwise described herein is presented for exemplary purposes only. The optimal configuration for the rotor 102 is application dependent, and can vary with factors such as the overall size and desired power output of the wind turbine 100, the anticipated wind conditions, etc. For example, larger turbines in the megawatt range have larger radii of rotation, and therefore can operate at higher tip speed ratios λ. A higher tip speed ratio yields a smaller pitch angle for the front airfoils 130, which results in smaller fluctuations in angle of attack αm.

It is known in the art that an airfoil for a wind turbine should have a thickness of at least 18 percent, expressed as the ratio of the maximum thickness (“tₘₐₓ”) to chord length (“c”) in order the have sufficient structural strength. Increasing the airfoil thickness slightly above this value can result in greater structural strength, lower drag, and a forward shift in the power curve. If the airfoil thickness is increased from 18 percent to 21 percent, the maximum power coefficient will remain the same, but will be reached at lower tip speed ratios λ. The lift curve slope (“C_{1α}”) is another important characteristic an airfoil, and is which is ideally related to the airfoil thickness as follows:

C_{1α}=1.8π(1+0.8 tₘₐₓ/c)≈2π

In the exemplary rotor 102, the front airfoils 130 have a thickness of approximately 21 percent, and the main airfoils 132 have a thickness of approximately 19 percent. Blades having thickness values within this range, in general, are easier to manufacture and are more resistant to distortion in comparison to thinner blades. The additional thickness results in a slight increase in the nose radii of the front airfoil 130 and the main airfoil 132, which is believed to increase the maximum lift coefficient (“C₁ₘₐₓ”) of the front airfoil 130 and reduce drag. It is believed that this configuration can also help to fine tune the pressure distribution along the front airfoil 130, since a more rounded nose reduces the potential for turbulent flow and flow separation.

The front airfoils 130 are substantially symmetric about their chord c_{f}, as discussed above. Although symmetric airfoils, in general, are less efficient than cambered airfoils, it is believed that this disadvantage can be substantially negated by the additional lift generated by the front airfoils due to the upwash effect from main airfoils 132, discussed below. This specific configuration the main airfoil 132 has a relatively small amount of camber, e.g., 1.25 percent, which the inventor has found can improve the performance of the blades 105 during operation in upwind conditions. A small amount of camber can be expected to induce some reduction in lift during downwind operation.

As noted above, the front airfoils 130 pivot through a range of pitch angles Φ_{f} from approximately zero to a maximum of approximately 15° when the rotor 102 is operating at a tip speed ratio X of approximately four. More specifically, the pitch angle Φ_{f} of the front airfoils 130 varies from about zero to about 15° as the front airfoils 130 operate under upwind conditions, i.e., as the front airfoils 130 move from an azimuth angle θ of zero to an azimuth angle of 180° as shown in FIG. 5. The pitch angle Φ_{f} of the front airfoils 130 varies from about zero to about −5° as the front airfoils 130 operate under downwind conditions, i.e., as the front airfoils 130 move from an azimuth angle of 180° to an azimuth angle of zero.

It is known in the art that operating a single airfoil at an angle of attack within a range of approximately four to approximately ten results in an optimal ratio of lift to drag coefficients (C₁/C_{d}). Accordingly, it is believed that operating the blades 105 with the angle of attack αₘ of the main airfoil 132 within the range of approximately zero to approximately 15° can result in a favorable overall lift to drag ratio for the blades 105. Moreover, it is believed that this range of αₘ results in the development of favorable torque characteristics during start-up of the rotor 102.

Although the fixed-pitch configuration of the main airfoil 132 is simple and practical, alternative embodiments can incorporate a pivoting main airfoil 132 configured to operate with a self-adjusting pitch angle of, for example, 3°. It is believed that such a configuration can provide substantial aerodynamic benefits when the main airfoil 132 is passing through azimuth angles at or near zero and 180°.

The tip speed ratio λ of a rotor such as the rotor 102 represents the ratio of the tip speed of the blades to the wind speed, or free stream air velocity V_{∞}. The rotor 102 is configured to operate with a tip speed ratio of approximately 4 when the free stream air velocity V_{∞}, is approximately eight meters per second. FIG. 8 is a table showing the tip speed ratios for the rotor 102 that correspond to free stream air velocities V_{∞} greater, and less than eight meters per second.

Three-dimensional flow through a rotor such as the rotor 102 will impart a spin to the wake generated by the rotor 102. This spin can reduce the useful proportion of the total energy content of the free stream airflow incident upon the rotor 102, thereby reducing the amount of useful mechanical energy that can be extracted from the air stream by the rotor 102. Due to this effect, the power coefficient (“Cₚ”) of the rotor 102 will be smaller than the theoretical maximum achievable power coefficient (16/27), or Betz limit, and the maximum power of the rotor 102 will be dependent upon the ratio of the energy components from the rotating motion to the translational motion of air stream. This ratio is determined by the tangential velocity of the rotor blades (“ω·r”) versus the free stream air velocity V_{∞}, and is represented by the tip speed ratio λ.

The optimum tip speed ratio (“λₒₚₜ”) is given by following equation:

λₒₚₜ≈4π/n

where “n”=the number of rotor blades.

The operating range for the tip speed ratio λ of a cyclogyro is known to lie between three and seven. When a Darrieus-type rotor is configured to operate at an optimum tip speed ratio of approximately five, it is known that its power coefficient Cₚ will be approximately 0.4. This suggests that for maximum power extraction, a rotor such as the rotor 102 should be operated at or near is optimum tip speed ratio λₒₚₜ. Because the rotor 102 includes three blades 105, its practical range of tip speed ratio is between three and five. Moreover, the rotor 102 is configured so that its solidity σ, i.e., ratio of blade area to total disk area, corresponds to a medium, or moderate solidity of ten percent to twenty percent. For a rotor having a solidity of approximately twenty percent, the power coefficient Cₚ should be optimal within a range of tip speed ratios of approximately 3.5 to approximately 4.0. Accordingly, due to its effect on the power coefficient Cₚ, the tip speed ratio can be used as a correcting variable to help optimize operation of the rotor 102 throughout a particular range of free stream air velocities V_{∞}, and to help reduce noise and negative torque generated by the rotor 102. Also, the tip speed ratio will affect the maximum angle of attack experienced by the main airfoil 132. At low tip speed ratios, i.e., less than three, the angle of attack of the main airfoil 132 could exceed its static stall angle (12°-16°), which in the case of unsteady flow can result in dynamic stall and loss of lift.

As noted above, the interaction of the circulation flows associated with the front and rear airfoils 130, 132 increases the imbalance between the pressure distributions across the top and bottom surfaces of both airfoils, which in turn increases the lift generated by the airfoils. An explanation for this effect follows.

The true physical sources of aerodynamic force on a body moving through a fluid are the pressure P and shear stress τ distributions exerted on the surface of the body. The net effect of the P and τ distributions integrated over the complete body surface is a resultant aerodynamic force R and a moment M on the body. The resultant force R can be split into tangential, and axial or normal forces as shown in FIG. 6.

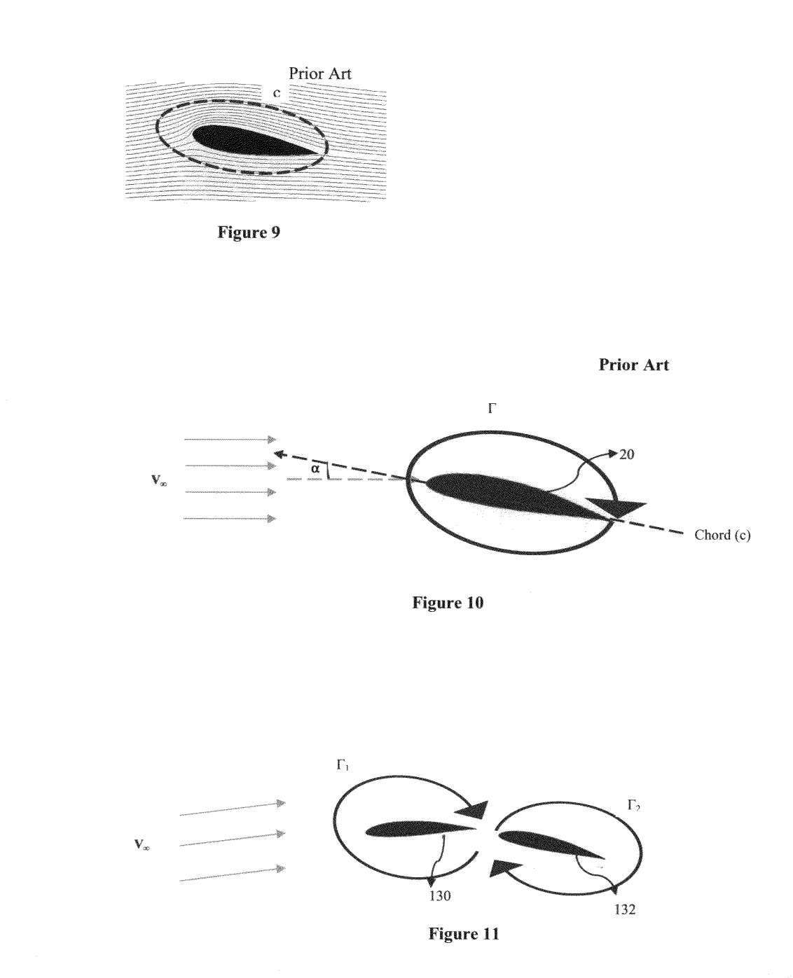

FIG. 9 depicts the flow field, i.e., streamlines, of an incompressible fluid over a conventional airfoil section 20. The curve C depicted in the figure can be any curve in the flow enclosing the airfoil. If the airfoil is producing lift, the velocity field around the airfoil will be such that the line integral of velocity V around C, i.e., the circulation F, will be finite:

Γ=∫CV·ds.

The circulation theory of lift is a mathematical expression relating to the generation of lift on an airfoil. It is generally much easier to determine the lift generated by a uniformly-shaped airfoil by calculating the circulation around the airfoil, as opposed to calculating the detailed surface pressure distribution along the airfoil. The above equation is directed to calculating of the circulation about the airfoil. Once the circulation Γ is obtained, then the lift per unit span (L′) on a uniformly-shaped airfoil follows from the Kutta-Joukowski theorem, as embodied in the following equation: L′=ρ_{∞}V_{∞}Γ, where ρ_{∞} air density and V_{∞}=wind velocity.

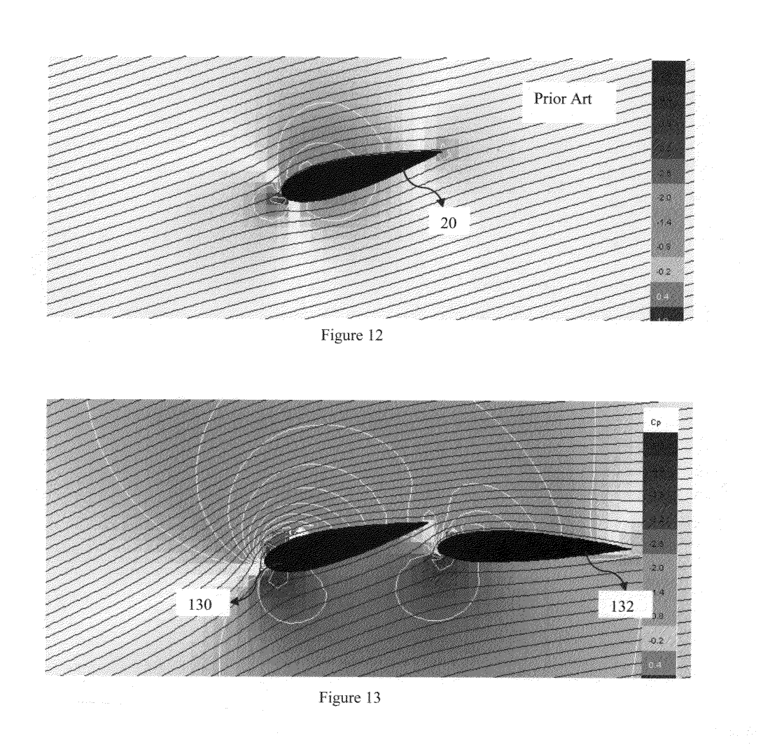

The Kutta-Joukowski theorem states that lift per unit span on a two-dimensional airfoil is directly proportional to the circulation Γ around the body. FIG. 10 is a schematic illustration of the so-called upwash and downwash effects on a single airfoil 20 representing the prior art. FIG. 12 depicts the flow field around the airfoil 20. When an airfoil such as the airfoil 20 is oriented at an angle of attack (“α”) in relation to the relative wind, a rotational effect in the form of circulation about the airfoil 20 occurs as a result of the viscosity of the air flowing over the airfoil 20, as shown in FIG. 10. This circulation, along with the free stream flow, can generate lift. As a result of the circulation about the airfoil 20, the air well in front of the airfoil 20, in addition to moving toward the airfoil 20, is also changing its direction or path so as to flow around the airfoil 20, as can be seen in FIG. 13. This change in direction begins to occur before the air reaches the leading edge of the airfoil 20, and causes some of the airflow initially approaching the airfoil 20 from a position below the leading edge to flow over the top of the airfoil 20. This is known as the upwash effect. Similarly, the air just aft of the airfoil 20 is rotating downward at it leaves the trailing edge. This is known as the downwash effect. The result of the upwash and downwash effects is a permanent bound vortex around the airfoil 20 that speeds up the airflow on the leeward side (top) of the airfoil 20, and slows down the airflow on the windward side (bottom), resulting in the generation of lift.

In the rotor 102, the front airfoil 130 and the main airfoil 132 are positioned proximate each other so that the circulation field associated with the front airfoil 130 interacts constructively with the circulation field associated with the main airfoil 132, as shown schematically in FIG. 11. In particular, it is believed that the relative positioning of the front airfoil 130 and the main airfoil 132 cause their respective circulation fields to combine in a manner that increases the upwash over the front of the front airfoil. The additional upwash increases the airflow and airspeed over the upper surface of the front airfoil 130, which in turn increases the lift generated by the front airfoil 130. Moreover, the presence of two circulation fields opposing the airflow on the windward, or lower sides of the front airfoil 130 and main airfoil 132 causes a further decrease in the airflow velocities along the lower surfaces, which in turn increases the pressure imbalance across the front and main airfoils 130, 132, thereby increasing the lift generated by the front airfoil 130 and the main airfoil 132.

FIG. 13 depicts a prediction of the flow field around an associated front airfoil 130 and main airfoil 132. The front airfoil 132 is operating at an angle of attack (α) of approximately 2°, and with coefficient of lift (C₁) of approximately 0.243. As can be seen from the streamlines depicted in FIG. 13, the bottom surface of the front airfoil 130 is located, in part, within the upwash associated with the leading edge of the main airfoil 132. Conversely, the upper surface of the main airfoil is located, in part, within the downwash associated with the trailing edge of the front airfoil 130.

As shown in FIG. 13, the streamlines above the front airfoil 130 are closely spaced, and the streamlines below the front airfoil 130 are widely spaced in comparison. This characteristic is indicative of a relatively large imbalance in the flow velocity (Bernoulli effect) and pressure distributions across the upper and lower surfaces of the front airfoil 130, which in turn indicates that the front airfoil 130 is generating a relatively large amount of lift. This is consistent with the relatively large coefficient of lift, approximately 2.217, predicted for the front airfoil 130 when operating under these conditions.

Conversely, the streamlines above and below the conventionally-configured airfoil 20 are similarly spaced, as shown in FIG. 12. This characteristic is indicative of little or no imbalance in the pressure distribution across the upper and lower surfaces of the airfoil 20, which in turn indicates that no substantial lift is being generated by the airfoil 20.

It is believed that the large difference between the lift generated by the single airfoil 20, and a comparable airfoil used as a front airfoil 130 and in conjunction with the main airfoil 132 is due to the above-noted interaction between the circulation fields of the front airfoil 130 and the main airfoil 132.

On a single airfoil such as the airfoil 20, i.e., the prior-art configuration, the airflow at the trailing edge must return to the free stream conditions, i.e., the Kutta condition. This is not the case with the front airfoil 130 of the rotor 102, due to its proximity to the circulation field of the main airfoil 132. In particular, due to the presence of the circulation field of the main airfoil proximate the trailing edge of the front airfoil 130, the airflow at the trailing edge of the front airfoil 130 needs only to return to the approximate velocity of the airflow present on the upper surface of the main airfoil 132. Because this velocity is higher than free stream velocity, the airflow at the trailing edge of the front airfoil 130 is believed to have a higher velocity than it would have without the effects of the main airfoil 132. The higher velocity increases the lift of the front airfoil 130, and lessens the potential for flow separation or stall.

Moreover, it is believed that the interaction between the circulation fields of the front and main airfoils 130, 132 causes the stagnation point on the main airfoil 132 to shift upwardly, toward the top of the leading edge of the main airfoil 132. This effect can be seen in FIG. 13. Shifting the stagnation point in this manner allows the main airfoil 132 to operate at a higher angle of attack before stalling than would otherwise be possible, which in turn increases the amount of lift that can be developed by the main airfoil 132.

It is also believed that the upwash flow associated with the main airfoil 132 causes the stagnation point on the front airfoil 130 to shift toward the bottom of the leading edge of the front airfoil 130. This effect can also be seen in FIG. 13. This change in the stagnation point increases the airflow and air velocity over the top surface of the front airfoil 130. Moreover, because the respective circulation fields around the front airfoil 130 and the main airfoil 132 are in the same direction, the amount of airflow and air velocity over the upper surface of the front airfoil 130 are higher than they would be absent the presence of the main airfoil 132. As a result of these effects, the top surface of the front airfoil 130 is believed to be a high-speed flow region, which causes the front airfoil 130 to develop a higher amount of lift than would be produced without the presence of the main airfoil 132.

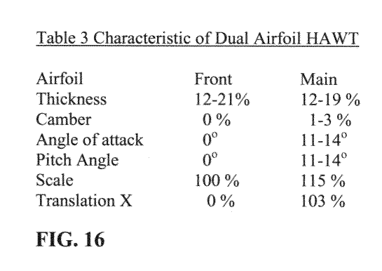

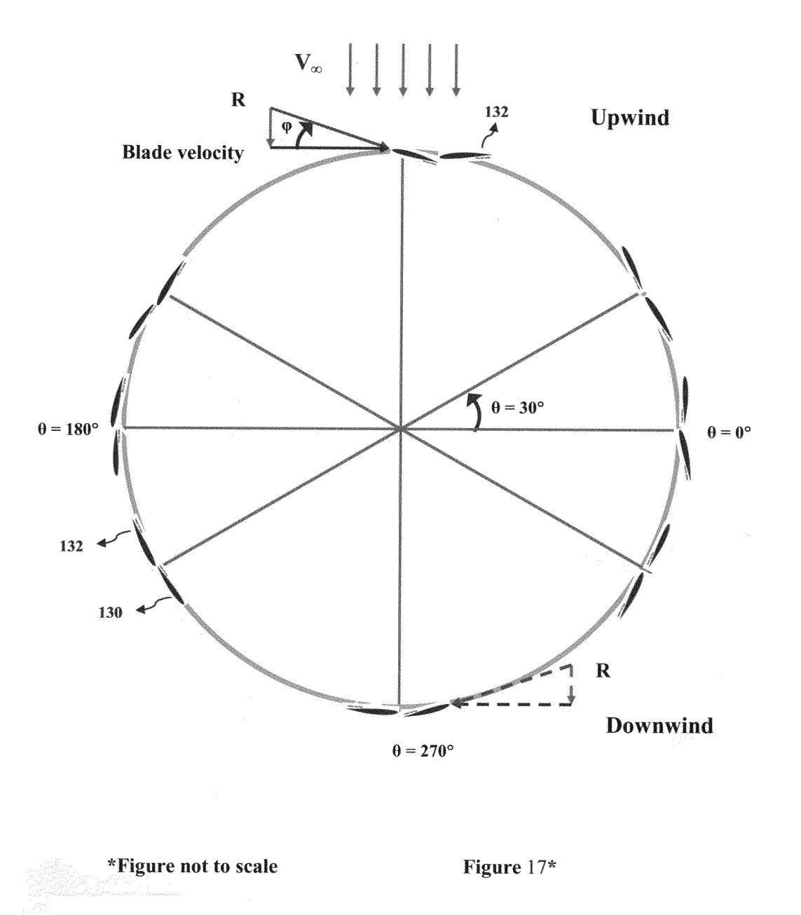

The concepts disclosed herein can also be applied to horizontal axis wind turbines with different configurations. For example, FIG. 14 is a diagrammatic front view of a rotor 200 for a horizontal axis wind turbine. The rotor 200 includes three equally-spaced blades 202 each having a fixed, i.e., non-pivoting, front airfoil 204 and a fixed rear, or main airfoil 206. As noted in FIGS. 14 and 16, the pitch angle Φ_{f} of the front airfoil is fixed at zero, so that the angle of attack of the front airfoil 204 is also zero during operation of the rotor 200. The main airfoil 206 is set with an angle of attack to be between approximately 11° and approximately 14°, as shown in FIGS. 14 and 16. The front airfoils 204 and the rear airfoils 206 are each mounted on an associated y-shaped support 214. The supports 214 are each fixed to a centrally-located hub 212.

FIG. 16 is a table describing exemplary structural and operational characteristics of the rotor 200. When the rotor 200 is operating at a tip speed ratio λ of approximately 4, the angle of attack αf of the front airfoil 204 is set at approximately zero; the pitch angle Φ_{f} of the front airfoil 204 is also set at approximately zero; the angle of attack αₘ of the rear or main airfoil 206 is set at between approximately 11° and approximately 14°; and the pitch angle Φₘ of the rear airfoil 206 is also set at between approximately 11° and approximately 14°. FIG. 15 depicts the predicted flow field over a front airfoil 204 and its associated main airfoil 206, and depicts effects in the flow field similar to those described above in relation to the front airfoils 130 and main airfoils 132.

The main airfoils 132 can be configured to pivot in alternative embodiments. As described in FIG. 17, by adjusting the eccentric point of the main airfoils 132, the main airfoils can be configured, for example, to pivot between angular positions of −3° and +3°, whereas the front airfoils 130 can be configured to pivot between angular positions of +15° and −5°, as in the rotor 102. As a result of its pivoting configuration, each main airfoil 132 will have an angle of attack of approximately −3° at an azimuth angle of zero, and an angle of attack of approximately +3° at an azimuth angle of 180°. Due to the non-zero angle of attack at these two positions the main airfoils 132 will generate a tangential force and a resulting torque that help pull the blade 132 forward. As a result, it is believed that a rotor configured in this manner will be self-starting, and will serve as camber for the front airfoils 130 in other positions in the upwind and downwind regions and have a more favorable lift coefficient and efficiency than a comparable rotor in which the main airfoils 132 are fixed.

The concepts disclosed herein have been described in connection with rotors for wind turbines for exemplary purposes only. The concepts can also be applied to other types of airfoils such as airplane wings, helicopter blades, hydrofoils, etc. For example, the higher coefficient of lift that can be achieved for an airplane wing incorporating the concepts disclosed herein can reduce the fuel consumption of the aircraft, and can permit the aircraft to take off and land at lower airspeeds, with the attendant benefits in safety and reduced runway length.

1. A rotor for extracting energy from a moving fluid, comprising:
a frame;
a first airfoil mounted on the frame and configured to pivot in relation to the frame; and
a second airfoil fixed to the frame proximate the first airfoil so that the second airfoil interacts aerodynamically with the first airfoil in response to the moving fluid.

2. The rotor of claim 1, wherein:
the frame comprises: a first hub; a first strut having a first end fixed to the first hub; and a first support member having a first end fixed to a second end of the first strut; and
the first airfoil is mounted on the first support member and is configured to pivot in relation to the first support member.

3. The rotor of claim 2, wherein: the frame further comprises a second hub, and a second strut having a first end fixed to the second hub; and the first support member has a second end fixed to the second strut.

4. The rotor of claim 3, wherein:
the frame further comprises:
a third strut having a first end fixed to the first hub;
a fourth strut having a first end fixed to the second hub;
a fifth strut having a first end fixed to the first hub;
a sixth strut having a first end fixed to the second hub;
a second support member having a first end fixed to a second end of the third strut, and a second end fixed to a second end of the fourth strut; and
a third support member having a first end fixed to a second end of the fifth strut, and a second end fixed to a second end of the sixth strut; and
the rotor further comprises:
a third airfoil coupled to the second support member and configured to pivot in relation to the second support member;
a fourth airfoil fixed to the frame proximate the third airfoil so that the fourth airfoil interacts aerodynamically with the third airfoil in response to the moving fluid;
a fifth airfoil coupled to the third support member and configured to pivot in relation to the third support member; and
a sixth airfoil fixed to the frame proximate the fifth airfoil so that the sixth airfoil interacts aerodynamically with the fifth airfoil in response to the moving fluid.

5. The rotor of claim 4, wherein the first, second, and third support members are located along an outer periphery of the frame.

6. The rotor of claim 4, wherein the first, second, and third support members are substantially equally spaced in an angular direction.

7. The rotor of claim 1, wherein: the first airfoil is operative to generate a first circulation field in response to the moving fluid; the second airfoil is positioned at least in part within the first circulation field; the second airfoil is operative to generate a second circulation field in response to the moving fluid; and the first airfoil is positioned at least in part within the second circulation field.

8. The rotor of claim 7, wherein an upper surface of the second airfoil is positioned at least in part within the first circulation field.

9. The rotor of claim 8, wherein a trailing edge of the first airfoil is positioned at least in part within the second circulation field.

10. The rotor of claim 1, wherein: the first airfoil is operative to generate a first circulation field in response to the moving fluid; the second airfoil is operative to generate a second circulation field in response to the moving fluid; and the first and second airfoil circulation fields overlap.

11. The rotor of claim 1, wherein the rotor is configured to rotate in response to the moving fluid, and the first airfoil is configured to maintain an angle of attack of approximately zero during rotation of the rotor.

12. The rotor of claim 11, wherein a center of gravity and a center of pressure of the first airfoil are substantially co-located.

13. The rotor of claim 11, wherein the first airfoil is substantially symmetric.

14. The rotor of claim 1, wherein the first airfoil is configured to generate a downwash in response to the moving fluid, and at least a portion of the second airfoil is located within the downwash.

15. The rotor of claim 14, wherein the second airfoil is configured to generate an upwash in response to the moving fluid, and at least a portion of the first airfoil is located within the upwash.

16. The rotor of claim 1, wherein the rotor is a vertical axis rotor wherein an axis of rotation of the frame and a longitudinal axis of each of the first and second airfoils extend substantially in the same direction.

17. The rotor of claim 1, wherein the rotor is a horizontal axis rotor wherein an axis of rotation of the frame extends in a first direction, and a longitudinal axis of the first airfoil extends substantially in a second direction, the first and second directions being substantially perpendicular.

18. A rotor for extracting energy from a fluid, comprising:
a frame;
a first airfoil coupled to the frame, wherein the first airfoil is operative to generate a downwash in response to relative movement between the first blade and the fluid; and
a second airfoil fixed to the frame proximate the first airfoil so that at least a portion of an upper surface of the second airfoil is positioned within the downwash of the first airfoil.

19. The rotor of claim 18, wherein the second airfoil is operative to generate an upwash in response to relative movement between the second blade and the fluid; and a trailing edge of the first airfoil is positioned within the upwash of the second airfoil.

20. (canceled)

21. A device for producing electricity, comprising a generator, and a rotor configured to extract energy from a moving fluid, the rotor comprising:
a frame coupled to the generator and configured to impart torque to the generator, wherein the generator generates electricity in response to the torque;
a first airfoil mounted on the frame and configured to pivot in relation to the frame; and
a second airfoil fixed to the frame proximate the first airfoil so that the second airfoil interacts aerodynamically with the first airfoil in response to the moving fluid.
